(19) United States
(12) Patent Application Publication
(10) Pub. No.: US 2008/0106521 A1
(43) Pub. Date: May 8, 2008

(54) Computer input system including finger stylus

(76) Inventor: Denise Darlene Nave, Auburn, WA (US)

Correspondence Address: LAW OFFICE OF POLLY L. OLIVER, 3134 Parkside Circle NE, Tacoma, WA, 98422, US

(21) Appl. No.: 11/593,901

(22) Filed: Nov. 6, 2006

(51) Int. Cl. G06F 3/041; G06F 3/033; G09G 5/00

(52) U.S. Cl. 345/173; 345/179; 345/168; 345/163

(57) ABSTRACT

A contact device typically embodied in a finger stylus is part of an overall input system for computer touch screens. Said contact device comprises a generally short, firm extension element having a distal end for establishing brief but discrete contact with the computer touch screen and is to be used, for instance, for making choices in a list of options appearing on a computer screen, sometimes in alternate combination with input from traditional keyboard typing or mouse usage. In operation, the user can position her hands over the keyboard in the usual manner and make both keyboard and touch screen inputs alternately without removing her eyes—or her focus—from the computer screen.

### FIELD OF THE INVENTION

This invention pertains generally to computer systems and accessories and more particularly to a touch screen contact device which can be Worn on the user's finger while typing as part of an overall input system.

### BACKGROUND OF THE FIELD

People use computers more and more frequently for many different applications in many different fields. Many of these computers now use touch screens for input as well as keyboards. Several computer applications require users to make choices on these touch screens in alternate combination with traditional keyboard typing; however, touching the screen with fingers to make these choices is not always advisable. Fingertips generally provide broad contact areas, not the discrete points necessary on said touch screens. Moreover, using fingertips unduly wears out the computer screen and makes it smudgy and grimy.

Even though other devices such as pens, pencils, and other styli may provide more discrete points of contact, using and touching with such other devices is not always easy. It requires interrupting one's focus on the computer screen to identify and pick up the pen, pencil, or other stylus and then to replace it on the desk or counter next to the keyboard after the input is made. These additional steps can add to the time required to accomplish the computer task at hand. So there needs to be a hand or finger stylus so that the user can easily input using both methods—keyboard and touch screen.

There have been attempts in the prior art to address this problem. For instance, Zigler's device in U.S. Pat. No. 5,747,748 covers a pen, pencil, or other pointed stylus making it more suitable for touch screen use. It includes a sheath for the elongated member (pen) which is shaped like the member, i.e., tapered at the point, and a tip coupled to the distal end of the sheath in the center, i.e., aligned with the point of the elongated member (pen). Zigler's tip therefore relies on the structure of the underlying elongated member (pen) for support and would not snugly fit or work with a users finger. Indeed, Zigler's device is not intended or use with a finger at all. Moreover, Zigler's tip is simply an extension of the sheath, i.e., the sheath is truncated at the distal end to make room for the tip, which simply fills the void defined by the removed sheath material.

Mortarelli's device in US Patent Application No. 2005/0093835 includes a disk-shaped base member and a tip. The disk-shaped base member is adhered to the fingertip with adhesive. This device is difficult to apply to the user's finger, and if it is not precisely positioned, may not be useful for quick inputting. Furthermore, setting it up requires the additional step of applying and setting up the adhesive, and so this device is just as time consuming as using no stylus at all.

### SUMMARY OF THE INVENTION

The present invention solves the above-mentioned problems by providing a streamlined device that can be worn by a user on a finger or thumb while typing and used to manually point to, and establish brief contact with, items appearing on a computer touch screen. The device enables the user to quickly and easily switch between typing on a computer keyboard and touching the screen where necessary, for instance to make a choice in a list of options. With this device, the user can switch back and forth several times during one computer session without having to stop to pick up a separate stylus or other contact device.

One embodiment of the invention comprises a finger (or thumb) cover (somewhat similar to a thimble) with an extension element—made of rubber or having a rubber tip—fixed thereon. The extension element typically will be a short, firm element and will extend from the front of the finger cover—e.g., at the fingertip. The entire finger stylus and/or the tip may be made of rubber or fabric for comfort, extruded plastic for durability, or any other appropriate material. The finger stylus may be offered in various sizes, colors, and patterns, and may even be made available in a style including a feature to accept costume jewelry insets for customization.

### BRIEF DESCRIPTION OF THE DRAWINGS

FIG. 1 is a perspective view of the preferred embodiment of the finger stylus;

FIG. 2 is a cross-sectional view of the stylus;

FIG. 3 is a top view of the preferred embodiment of the finger stylus; and

FIG. 4 is a perspective view of an alternate embodiment of the finger stylus with maximum length extension element marked (notched) so it can be cut by the user to her desired length.

### DETAILED DESCRIPTION

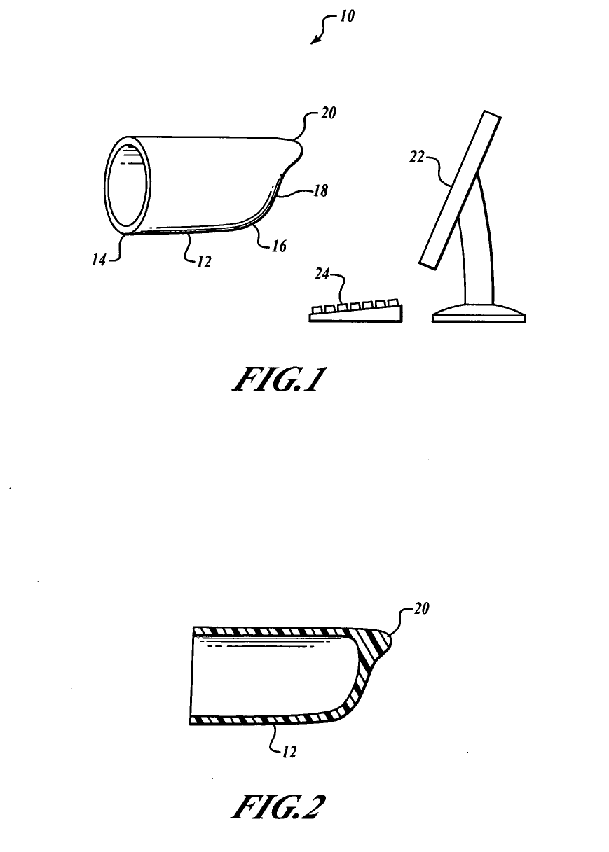

FIG. 1 shows the invention of the finger stylus 10 according to the preferred embodiment as it is to be held on a user's finger and positioned toward a computer touch screen. The preferred embodiment comprises a finger cover 12 which generally is a slightly tapered cylinder with the generally circular first end 14 of larger diameter than the second end 16. The first end 14 is open—for insertion of the user's finger—but the second end 16 is to be closed, typically with a rounded outwardly-projecting cap portion 18 designed to snugly fit the user's finger tip. The cover 12 could also be sized to fit a user's thumb instead of a finger.

Extending from the closed end or the cap portion 18 is the generally short, firm extension element 20 used to contact the computer touch screen 22, The extension element 20 may be made of rubber or may have a rubberized tip (rubber may be used to provide a firm contact point that will contact the touch screen with integrity but will not unduly wear the computer screen). The extension element 20 is permanently attached to the cap portion 18 (indeed the finger stylus may be a one-piece molded unit as shown in FIG. 2) and is offset from its geometric center so that it extends generally longitudinally from the cover and the user's fingertip, which is inserted into the cover 12 and abuts the cap portion 18. Alternatively, the extension element 20 may extend at an angle from said cover. The extension element 20 may be tapered towards the distal end and may be shaped to come to a discrete point or a blunt point at the tip. The extension element 20 should be short enough for stability and to avoid interference with adjacent keys on the keyboard 24, and may be provided in different lengths, so that different users may choose lengths most comfortable for them. In alternate embodiments, the permanently affixed extension element 20 may be provided in a maximum length with measured notches or scores 30 so that the user may cut the extension element 20 to the desired length (see FIG. 4).

The invention 10 may be provided as a combination element along with a computer touch screen 22 and/or a traditional computer keyboard 24 and/or computer mouse (not shown) to constitute an input system for computer programs and applications that use touch screens. Such a system using the instant invention of the finger stylus 10 allows that a user can quickly and easily switch between finger stylus 10 and keyboard 24 or mouse for making inputs to the program, keeping her eyes and focus on the screen.

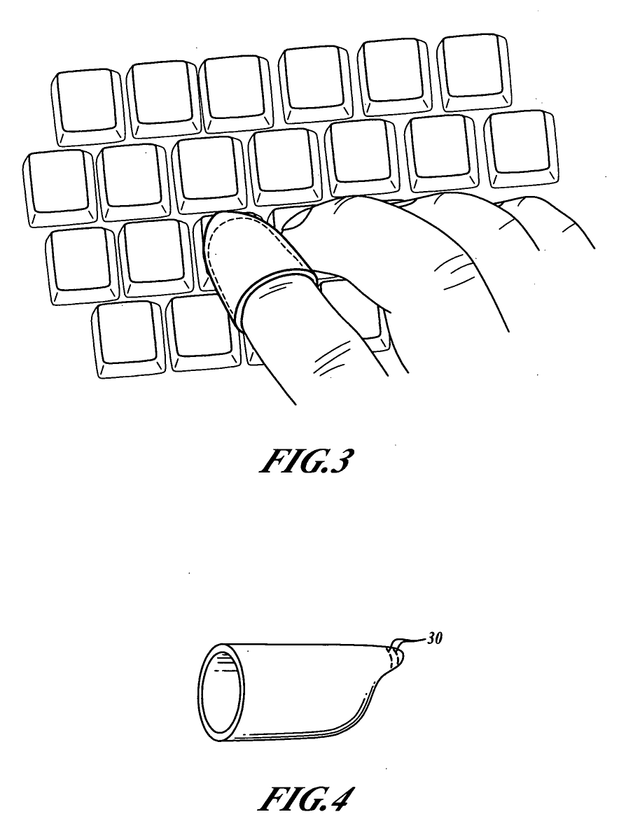

In operation, the user inserts her finger (or thumb) into the finger stylus cover 12 through the open end 14 completely until her fingertip makes contact with the closed end cap portion 18, and said stylus cover fits snugly around her finger, positioning said cover such that the sort, firm extension element 20 extends longitudinally from her fingertip. (The optimum alignment may be with the extension element 20 located just above the center of the user's fingertip, i.e., somewhat aligned with her fingernail. This alignment allows that the extension element will not interfere with typing or other activities.) The user then positions herself in front of the touch screen 22 with her hands poised over the keyboard 24 in the usual manner for typing as shown in FIG. 3. As the user types, she observes the computer touch screen 22, and when a list with choices is presented, she selects at least one choice by bringing the distal end—or tip—of said short, firm extension element 20 into physical contact with the computer touch screen 22 in such a manner as to manifest her choice. The user may then return to typing if necessary without any interruption in the workflow.

What is claimed is:

1. A finger stylus comprising:
A generally cylindrical cover with a first open end for insertion of a finger or thumb and a second, generally rounded, outwardly-projecting closed end, said rounded, outwardly-projecting closed end having a geometric center,
A generally short, firm extension element extending from said closed end and offset from said geometric center, said element having a distal end extending generally longitudinally from said cylindrical cover.

2. The finger stylus of claim 1 wherein said cover is made of a flexible, rubber-type material capable of and designed to hug the finger upon insertion into the cover, such that said short, firm extension element is positioned proximate the tip of the finger and extends generally longitudinally therefrom.

3. The finger stylus of claim 1 wherein said short, firm, extension element extends at an angle from said cover.

4. The finger stylus of claim 2 wherein said distal end of said short, firm extension element tapers to a discrete point so as to provide accuracy when in contact with a computer touch screen.

5. The finger stylus of claim 2 wherein said distal end of said short, firm extension element tapers to a blunt point so as to provide accuracy when in contact with a computer touch screen.

6. The finger stylus of claim 1 wherein said generally cylindrical cover tapers from said first open end toward said second dosed end.

7. The finger stylus of claim 6 wherein said generally cylindrical cover and said short, firm extension element are injection molded as a one-piece unit.

8. The finger stylus of claim 6 wherein said short, firm extension element extends longitudinally from said slightly rounded, outwardly-projecting closed end of said cover offset from said geometric center.

9. The finger stylus of claim 8 wherein said extension element tapers towards said distal end.

10. The finger stylus of claim 9 wherein said extension element is proffered with a plurality of score lines so that the user may cut the element to a desired length.

11. An input system for a computer program comprising a combination finger stylus and touch screen, comprising a finger stylus worn by a user having a cover circumscribing a user's finger and an extension element attached thereto used to make a discrete choice from among several choices offered on a computer touch screen, said choice made by bringing said extension element into physical contact with said computer touch screen.

12. The input system of claim 11 wherein said extension element is rubberized or rubber-tipped at the distal end and tapers from said cover towards said distal end.

13. The input system of claim 11 further comprising a keyboard to work in cooperation with said finger stylus for making inputs to said computer program.

14. The input system of claim 11 further comprising a mouse to work in cooperation with said finger stylus for making inputs to said computer program.

15. A method for making periodic choices on a computer touch screen using an input system including a traditional computer keyboard and a finger stylus having a cover with open end and an extension element attached to the closed end comprising the steps of:
A user inserting her finger into said finger stylus cover through the open end completely until her finger tip makes contact with the closed end of said stylus cover and said stylus cover fits snugly around her finger:
Said user positioning said cover such that the short, firm extension element extends longitudinally from her finger tip and does not interfere with typing;
Said user observing the computer touch screen, including the choices outlined thereon and selecting at least one choice by bringing the distal end of said short, firm extension element into physical contact with the computer touch screen in such a manner as to manifest her choice; and
Said user returning her finger to the typing position and resuming typing.

16. The method of making choices of claim 15 further including a step of making input with a mouse.

17. The method of claim 15 further including a step of the user selecting a desired length of the extension element and cutting said extension element according to proffered score lines.
